(19) United States
(12) Patent Application Publication
(10) Pub. No.: US 2009/0074384 A1
(43) Pub. Date: Mar. 19, 2009

(54) APPARATUS FOR PLAYBACK OF IMAGES FROM A SERIAL VIDEO DATA STREAM

(75) Inventor: Sebastiaan Antonius Fransiscus Arnoldus Van Den Heuvel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,230

(22) PCT Filed: Nov. 15, 2005
(86) PCT No.: PCT/IB05/53762

§ 371 Date: May 14, 2007

(30) Foreign Application Priority Data
Nov. 18, 2004 (EP) 04105874.4

(51) Int. Cl. H04N 5/00; H04N 7/26

(52) U.S. Cl. 386/124; 386/126; 386/E05.001

(57) ABSTRACT

The invention relates to an apparatus and a method for playback of images from a serial video data stream, the apparatus comprising receiving means for receiving a serial video data stream comprising content video data and commercial video data, storage means for storing the serial video data, output means for conveying the serial video data to a video display at a rate related to the rate of reception of the serial video data stream and timer means, wherein the device is adapted to interrupt the conveyance of the content video data and to convey commercial video data during predetermined periods. The invention also relates to an optical memory disk and to a digital broadcast signal, comprising content video data and commercial video data, wherein the disk or the signal comprises data determining the interruption of the conveyance of the content video data and the conveyance of commercial video data during pre-determined periods.

The invention relates to an apparatus for playback of images from a serial video data stream.

Apparatuses of this kind are known in form of digital video recorders for digital broadcast signals of both terrestrial and satellite nature. They are also known in the form of digital video players which are adapted to playback a serial video stream from a pre-recorded storage disk. The invention is applicable to a situation wherein the disk is not a disk recorded by a private person but rather a commercially available disk.

Broadcast signals, in particular broadcast signals which can be received free are usually provided with commercials. Often the costs of the broadcasts are born by the advertisers. Herein the term ‘free’ is understood to mean without the use of decoders, descramblers or similar equipment. When viewing the signals in real time the commercials cannot be skipped. It is however possible to record these commercials on a disk, like a DVD and to skip the commercials during playback. From the viewpoint of the broadcaster this is an undesirable situation, as their advertisers are not sure whether their commercials are viewed by the viewers or not.

A similar situation exists for DVD's or other carriers of serial digital video data stream. It is expected that within the foreseeable future these carriers will be distributed free, against a low price or as a commercial incentive. In those cases the costs for the video content and the production of the DVD's can be borne by including commercials onto the carrier. This product can lead to a similar situation; that is a situation wherein a party in the system prefers that the commercials are viewed by the viewers.

The invention is defined by the independent claims.

The dependent claims set out at least some of the embodiments.

It is for reasons mentioned above desirable that the device is adapted to interrupt the conveyance of the content video data and to convey commercial video data during pre-determined periods.

By these features the display of the commercials is not dependant from the times at which the commercials are inserted into the video stream, but rather from information present on carrier or in the broadcast signal, so that the display of the commercials is imperatively determined by the system and the control is taken away from the viewer.

These advantages are also reached by a method for playing back a digital video signal, the method comprising: receiving a serial video data stream comprising content video data and commercial video data, storing at least the commercial video data, conveying the serial video data stream to a video display and keeping time during the conveying of the serial video data stream to the video display, and wherein the display of the content video data and displaying commercial video data during pre-determined periods.

It is emphasized that it is important for the invention that the rate of the digital signals entering the apparatus and leaving the apparatus are related. Generally speaking these rates will be equal, but, with the increase of digital processing, like error correction, it is possible that the two rates are not always exactly equal.

As stated before the features of the invention are applicable in a situation wherein the serial video stream is formed by a broadcast signal. Then the apparatus may be adapted to receive such a broadcast serial video data stream from a broadcast station.

Only when the apparatus comprises a memory or a storage device, there is a possibility that the viewer may skip the commercials. Although analogue devices, like analogue video cassette recorders are not excluded from the invention, the advantages of the invention appear more clearly when the storage means comprise a digital hard disk. This feature is known per se from normal digital video recorders.

Instead of a hard disk memory, the storage means may also comprise means for storing data on an optical memory disk. Herein these disks are commonly exchangeable.

As stated above, the digital video signal may also come from a commercially available optical memory disk like a DVD. Other formats are however not excluded.

The features according to the main claim mentioned above provide features determining the display of the commercials at predetermined times, that is that the display of the commercials is not determined by the viewer. Nevertheless the viewer still has the possibility to skip the commercials by fast-forward of the transport of the storage device. This would be contrary to the aim of the invention. To avoid this possibility which is undesirable from the viewpoint of the broadcaster or the distributor of the disks, a preferred embodiment of the invention provides the feature that the apparatus is adapted to inhibit trick play during the pre-determined periods.

The same advantages are reached when a method is applied wherein trick play during the display of commercial video data is inhibited.

The determination of the times at which the commercials are displayed offers several possibilities. On of those possibilities is the interruption of the conveyance of the content video and the start of the conveying of the commercial video data at predetermined times. This form the most basic option, comparable to normal broadcasts wherein the commercials are shown for instance every 20 or 30 min.

The same counts for a such a method wherein the display of the content video data is interrupted at predetermined times and the display of the commercial video data.

It is however also possible to have the times at which the displaying of the content is interrupted determined by data incorporated in the data stream. This is an attractive option with movies in which the commercials can be located in the appropriate, like high-tension scenes in the movies. This leads to an embodiment wherein the apparatus is adapted to interrupt the conveyance of the content video data and to start conveying the commercial video content at times which are determined by data incorporated into the video stream data.

The same advantage is reached when the display of the content video data is interrupted at times which are determined by data incorporated into the video stream data and wherein the commercial video content is displayed.

Another possibility is to adapt the apparatus to interrupt the conveyance of the content video data and to convey specific parts of the commercial video content at times determined by data incorporated into the video stream data. This possibility is for instance relevant in sports programs wherein a commercial after the display of a tennis match may be followed by a commercial for tennis balls and after the display of a football match, a commercial for football shoes may be shown.

This is covered by a method of interrupting the display of the content video data and displaying specific parts of the commercial video content at times determined by data incorporated into the video stream data.

As explained before, the signal stream may be coming from a broadcast signal, but also from a disc. Therefore the invention provides an optical memory disk, comprising content video data and commercial video data, wherein the disk comprises data determining the interruption of the conveyance of the content video data and the conveyance of commercial video data during pre-determined periods.

Also in the case of a disk, it can be attractive to provide such a disk, comprising data determining the time of interruption of the conveyance of the content video data and the conveyance of commercial video data during pre-determined periods. The advantages of this embodiment appear in video content which can easily be interrupted both at random times and at times with regular intervals.

The commercials may be chosen so that they bear a relation with the normal video content in which they are inserted. In such a case it is attractive if the disk comprises data determining specific parts of the commercial content which is to be conveyed during the interruptions.

The advantages of the preferred embodiments mentioned above in relation to the disks, may also be applicable to similar situations wherein the signals are supplied through broadcast. It is thus attractive to provide a digital broadcast signal, comprising content video data and commercial video data, wherein the signal comprises data determining the interruption of the conveyance of the content video data and the display of commercial video data during pre-determined periods.

Consequently these advantages also appear from a digital broadcast signal of the kind referred to above comprising data determining the times of interruption of the conveyance of the content video data and the conveyance of commercial video data during pre-determined periods.

The same counts for a digital broadcast signal comprising data determining specific parts of the commercial content which is to be conveyed during the interruptions.

Subsequently the invention will be elucidated with the help of the following drawings:

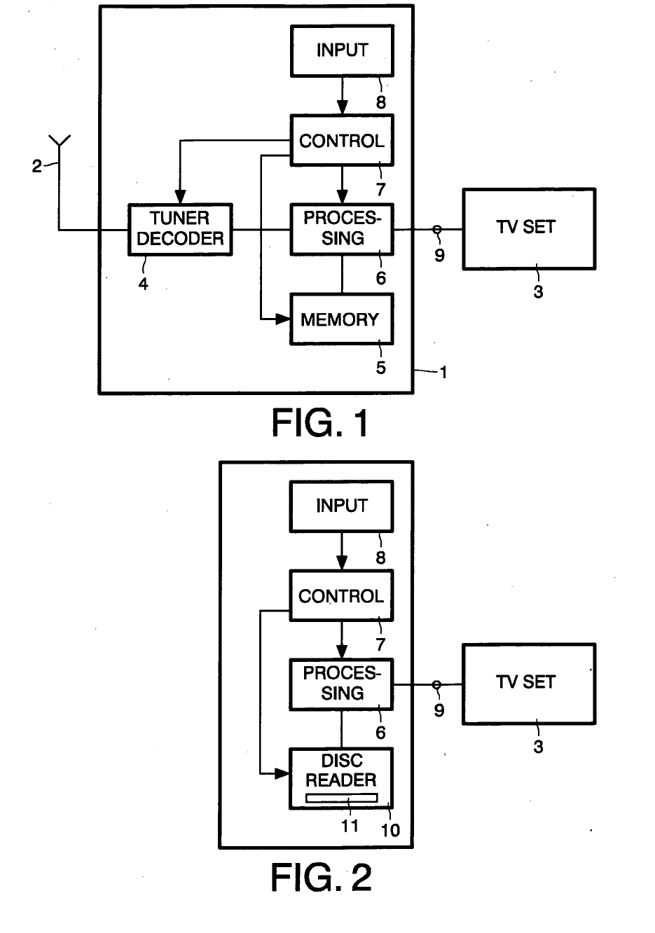

FIG. 1 a diagram of a first embodiment of the invention;

FIG. 2 a diagram of a second embodiment of the invention;

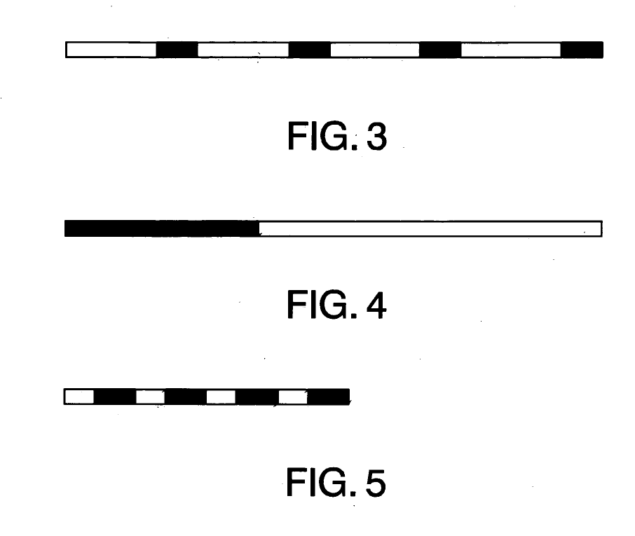

FIG. 3 a time diagram of an input signal used to explain the invention;

FIG. 4 a time diagram of an alternative input signal used to explain the invention; and

FIG. 5 a time diagram of an output signal.

The invention can be embodied in a digital video recorder as depicted in FIG. 1. This video recorder 1 has its input connected to an aerial 2, and its output is connected to a tv set 3. It is however also possible to use such a digital video recorder in other configurations, that is with its input connected to a satellite receiver, or integrated into a home video system. The way the video recorder is connected is however not relevant for the invention, despite the fact that it must be connected to a source of a digital video signal. The video recorder comprises the common components of such an apparatus, like a tuner/decoder 4, a digital memory 5, a process unit 6, a control unit 7, an input device 8. It is output 9 is connected to the input of the tv set 3.

Until so far this video recorder 1 complies with prior art digital video recorders. It is however noted that in order to be able to execute the method according to the invention, the video recorder 1 must be able to receive and process digital input signals.

Further it is noted that the memory may be formed by a hard disk, as is already known in digital video recorders. It is also possible that the memory is formed by a writer/reader for digital optical storage disks, like DVD's, together with such an optical disk or a set of optical disks.

The output signal may be formed by an analogue signal as is common for the connection between a video recorder, but preferably it is a digital signal. The choice of the nature of the output signal or rather wether an D/A-converter should be incorporated into the video recorder will depend on the proliferation of digital interconnections between video apparatuses. The output signal to which the claims refer is a digital signal, that is the input signal of the D/A-converter if the ‘real’ output signal is of analogue nature.

The invention relates to the control unit 7 which is adapted to execute the normal functions of such a control unit. The invention appears from the fact that the control unit is adapted to interrupt the normal conveying of the content signal to the tv set at predetermined times and to convey commercial content. This is an advantageous feature in situations wherein the digital input signal is presented to the viewer at no or little cost. Usually the costs for the video content are borne by advertisers. By making viewers imperatively see the commercials of the advertisers, advertisers are more willing to invest in this kind of advertising.

The predetermined times can depend on the real time. In this situation the times at which a commercial starts may be every 15 minutes, every 20 minutes or similar.

It is however also possible that the times at which the commercials are shown, are determined by the content of the digital video stream. This allows to show the commercials at appropriate times of the main content. Another possibility is to choose the commercials from a set of commercials present in the memory.

The above-mentioned embodiment is especially adapted to receive signals from a broadcast channel. As stated above it also possible to distribute video signals in the form of DVD's or other carriers of digital video information. For such situations the embodiment shown in FIG. 2 is applicable; herein the invention resides—again—in the control unit 7, but the signal is presented from a disk 11 inserted into the disk player 10. In practice this disk player will also be equipped for recording disks, but that function is irrelevant for the present embodiment. The disc 11 inserted into the player 10 contains a digital video stream with the same properties as the incoming video stream in the preceding embodiment. Therefore the same variations can be applied.

It is possible to combine both embodiments into a single apparatus, or rather a video recorder which is adapted to fulfill both functions, that is on a video stream coming from a external serial source, wherein the signal can be stored into a memory and on a video stream which can be read out from a disc, in particular a disc from an external source, that is a disc which was not recorded by the viewer himself.

Finally FIG. 3 shows an example of an incoming video signal, wherein portions of content signal are interleaved with portions of commercial signal. The invention is however also applicable to situations wherein the input signal comprises initially consecutively the commercial portions and subsequently the content video as depicted in FIG. 4. In both cases the invention provides the feature that the output signal comprises the content signal, but wherein the content signal is interrupted for conveying portions of the commercial signal, just the same as is depicted in FIG. 3.

The effect of the feature that the trick play is inhibited during the display of commercials is depicted in FIG. 5. FIG. 5 shows a situation wherein the viewer has switched on the fast forward function while displaying the picture. As appears from this figure the fast forward function is inhibited during the display of the commercials, and after each commercial the trick play, in this case the fast forward is resumed, making sure that the viewer sees the commercials completely.

1. Apparatus for playback of images from a serial video data stream, comprising:
receiving means for receiving a video data stream comprising content video data and commercial video data;
output means for conveying the video data to a video display
characterized in that
the device is adapted to interrupt the conveyance of the content video data and to convey commercial video data during pre-determined periods, which are determined by the timer means.

2. Apparatus as claimed in claim 1, wherein the apparatus comprises a storage device for storing the video data.

3. Apparatus as claimed in claim 1, wherein the video data is conveyed by the output means at a rate related to the rate of reception of the serial video data stream.

4. Apparatus as claimed in claim 1, further comprising a timing device.

5. Apparatus as claimed in claim 1, characterized in that the apparatus is adapted to receive a broadcast video data stream from a broadcast station.

6. Apparatus as claimed in claim 5, comprising a storage device for storing the received data stream.

7. Apparatus as claimed in claim 6, characterized in that the storage device comprise a hard disk memory.

8. Apparatus as claimed in claim 2, characterized in that the storage device comprise means for storing data on an optical memory disk.

9. Apparatus as claimed in claim 1, characterized in that the apparatus is adapted to receive a serial video stream from an optical memory disk.

10. Apparatus as claimed in claim 1, characterized in that the apparatus is adapted to inhibit trick play during the pre-determined periods.

11. Apparatus as claimed in claim 1, characterized in that the apparatus is adapted to interrupt the conveyance of the content video data and to start conveying the commercial video data at predetermined times.

12. Apparatus as claimed in claim 7, characterized in that the apparatus is adapted to interrupt the conveyance of the content video data and to start conveying the commercial video content at times which are determined by data incorporated into the video stream data.

13. Apparatus as claimed in claim 8, characterized in that the apparatus is adapted to interrupt the conveyance of the content video data and to convey specific parts of the commercial video content at times determined by data incorporated into the video stream data.

14. Optical memory disk, comprising content video data and commercial video data, characterized in that the disk comprises data determining the interruption of the conveyance of the content video data and the conveyance of commercial video data during predetermined periods.

15. Optical memory disk as claimed in claim 10, characterized in that the disk comprises data determining the interruption of the conveyance of the content video data and the conveyance of commercial video data during pre-determined periods.

16. Optical memory disk as claimed in claim 10, characterized in that the disk comprises data determining specific parts of the commercial content which is to be conveyed during the interruptions.

17. Digital broadcast signal, comprising content video data and commercial video data, characterized in that the signal comprises data determining the interruption of the conveyance of the content video data and the display of commercial video data during pre-determined periods.

18. Digital broadcast signal characterized by data determining the times of interruption of the conveyance of the content video data and the conveyance of commercial video data during predetermined periods.

19. Digital broadcast signal characterized by data determining specific parts of the commercial content which is to be conveyed during the interruptions.

20. Method for playing back a digital video signal, comprising:
receiving a serial video data stream comprising content video data and commercial video data:
conveying the serial video data stream to a video display: and
characterized by
interrupting the display of the content video data and displaying commercial video data during pre-determined periods.

21. Method as claimed in claim 16, characterized by inhibiting trick play during the display of commercial video data.

22. Method as claimed in claim 16, characterized by interrupting the display of the content video data and displaying the commercial video data at predetermined times.

23. Method as claimed in claim 18, characterized by interrupting the display of the content video data and displaying the commercial video content at times which are determined by data incorporated into the video stream data.

24. Method as claimed in claim 18, characterized by interrupting the display of the content video data and displaying specific parts of the commercial video content at times determined by data incorporated into the video stream data.

25. Computer program product for programming a computer processor to carry out the method as claimed in claim 20.

26. Record carrier carrying the computer program product as claimed in claim 25.
